(19) United States
(12) Patent Application Publication
(10) Pub. No.: US 2012/0285296 A1
(43) Pub. Date: Nov. 15, 2012

(54) Apparatus for Filing a Saw Chain and Guide for a File Holder

(76) Inventors: Jan Foehrenbach, Stuttgart (DE); Christine Huentz, Stuttgart (DE)

(21) Appl. No.: 13/469,959

(22) Filed: May 11, 2012

(30) Foreign Application Priority Data
May 11, 2011 (DE) 10 2011 101 173.4

(51) Int. Cl. B23D 63/16

(52) U.S. Cl. 76/80.5

(57) ABSTRACT

An apparatus for filing a saw chain has a guide for a file holder, a file and a saw chain. The saw chain has cutting teeth wherein a depth limiter is arranged leading each cutting tooth. The guide has a placement part, which can be seated on the saw chain, and a carriage. The carriage accommodates the file holder. The carriage is mounted on the placement part in a displaceable manner in a displacement direction transversely to the longitudinal direction of the saw chain. The file holder is guided at an angle to this longitudinal direction and is supported on the cutting tooth to be filed and on the depth limiter. For a guide for the file holder, the carriage has two parallel side guides, which are arranged at a distance from each other, are arranged perpendicularly to the displacement direction, and delimit a receptacle for the file holder.

### CROSS REFERENCE TO RELATED APPLICATION

This application claims priority of German patent application no. 10 2011 101 173.4, filed May 11, 2011, the entire content of which is incorporated herein by reference.

### FIELD OF THE INVENTION

The invention relates to an apparatus for filing a saw chain, having a guide for a file holder, a file holder, a file and a saw chain as well as a guide for a file holder with a file.

### BACKGROUND OF THE INVENTION

U.S. Pat. No. 4,719,823 discloses an arrangement for filing a saw chain, having a guide for a file holder. The guide for the file holder has a channel which can be placed on the saw chain. The file holder is subsequently fixed on the saw chain by way of fixing elements. During filing, the file holder is located between a side guide and the cutting tooth to be filed. In order to achieve good guidance for the file holder, the distance between the cutting tooth and the side guide must be set exactly.

U.S. Pat. No. 5,241,882 discloses a guide for a file, which includes an attachment part and a carriage. The file is guided directly in the guide.

### SUMMARY OF THE INVENTION

It is an object of the invention to provide a simplified apparatus for filing a saw chain. It is a further object of the invention to provide a guide for a file holder having a file.

The apparatus of the invention is for filing a saw chain defining a longitudinal direction. The saw chain has a plurality of cutting teeth and a plurality of depth limiters associated with and disposed ahead of corresponding ones of the cutting teeth viewed running in the longitudinal direction of the saw chain. The apparatus includes: a file; a file holder for holding the file; a guide configured for the file holder; the guide having a placement part configured to be placed on the saw chain; the guide including a carriage configured as a receptacle for the file holder; the carriage being mounted on the placement part so as to be displaceable in a displacement direction transverse to the longitudinal direction of the saw chain; the file holder being guided on the carriage at an angle (ε) to the longitudinal direction of the saw chain; and, the file holder being configured to be supported on the one of the cutting teeth of the saw chain which is to be filed and on the depth limiter corresponding to the one cutting tooth which is to be filed.

The guide of the invention is for a file holder having a file for filing a saw chain. The guide includes: a placement part configured to be seated on the saw chain; a carriage mounted on the placement part in such a manner so as to be displaceable in a displacement direction; the carriage having two parallel side guides; the side guides being arranged at a distance to each other and perpendicular to the displacement direction; and, the side guides delimiting a receptacle for the file holder.

The guide serves only to fix the direction in which the file holder is to be arranged in relation to the cutting tooth. Otherwise, the file holder is guided via the cutting tooth and the leading depth limiter. Because the carriage is mounted movably in the displacement direction, the carriage with the file holder can be easily adjusted with increasing wear of the cutting tooth. The expression “transversely to the longitudinal direction of the saw chain” refers to each direction which encloses an angle deviating from 0° with the longitudinal direction of the saw chain, that is, all directions with the exception of the direction parallel to the longitudinal direction of the saw chain.

Advantageously, when the guide is placed on the saw chain, the displacement direction is perpendicular to the roof edge of the cutting tooth which is to be filed. As a result, the angle of the file holder to the cutting tooth is retained during displacement. Good guidance results when the file holder is guided between two side guides of the carriage. As a result, filing in the given direction is made possible in a simple manner. Lifting off of the file holder from the side guide, as is possible in the case of a guide on only one longitudinal side, can be avoided.

Advantageously, when the file holder is arranged in the receptacle, there is little play between the file holder and the receptacle, and so the file holder can be easily inserted into the receptacle and can be detached therefrom. Because there is only little play, exact guidance of the file holder is achieved. Advantageously, the side guides extend parallel to each other, wherein the distance between the side guides corresponds to approximately 100% to approximately 120% of the width of the file holder. It is considered especially advantageous to have little play between the file holder and the side guides.

Advantageously, the placement part has at least two cut-outs which are associated with each other and by way of which the placement part can be placed on the saw chain. The center line of the two cut-outs advantageously encloses, with the side guides of the carriage, an angle which results in an angle of 90° with a tooth angle of the saw chain. As a result of the alignment of the two cut-outs, the angular position of the placement part with respect to the longitudinal direction of the saw chain is predetermined in design terms. On account of the specified angle sum of 90°, the file holder in the receptacle is always guided parallel to the leading top edge of the cutting tooth to be filed. The cut-outs which are associated with each other are advantageously arranged in parallel wall sections of the placement part. The distance between the cut-outs which are associated with each other is advantageously approximately four times the pitch of the saw chain. As a result, one of cut-outs can be placed on the two connecting links leading the cutting link and the other, associated cut-out can be placed on the two connecting links trailing the cutting link to be filed. In this case, the cut-outs are advantageously introduced into the region between the rivet pins. Advantageously, the guide has two first cut-outs, the center line of which encloses, with the side guides of the carriage, an angle which results in an angle of 90° with the tooth angle of the right-hand cutting tooth, and two second cut-outs, the center line of which encloses, with the side guides of the carriage, an angle which results in an angle of 90° with the tooth angle of the left-hand cutting tooth. By moving the placement part, the alignment of the carriage can be adapted to left-hand or right-hand cutting teeth. Thus, only one carriage and one cut-out for the file holder are needed for filing left-hand and right-hand cutting teeth. This results in a small overall size of the guide.

Advantageously, the width of the cut-outs is larger than the width of the saw chain between two rivet pins of a connecting link and smaller than the width of a rivet pin. As a result, the placement part is secured in a simple manner between the two rivet pins in the longitudinal direction of the saw chain. Additional means for fixing the placement part are not required. In order to ensure that the file holder only rests on the cutting tooth and the leading depth limiter and not additionally on the base of the receptacle, it is provided that the tops of the cut-outs lie in a plane which projects through the receptacle for the file holder. The imaginary plane in which the tops, that is to say the top edges of the receptacles, lie thus extends through the receptacle and is not arranged below the receptacle. The plane runs at a distance from the base of the receptacle and is located closer to the file holder than the base of the receptacle. The base of the receptacle is in this case formed by at least one cross piece which connects the side guides to each other. Advantageously, at least one tongue for movably mounting the carriage on the placement part is arranged on the cross piece. This results in a simple structure.

For a guide for a file holder having a file, the guide having a placement part which can be seated on a saw chain and a carriage which is mounted on the placement part in a displaceable manner in a displacement direction, it is provided that the carriage has two parallel side guides which are arranged at a distance from each other, are arranged perpendicularly to the displacement direction, and delimit a receptacle for a file holder. On account of the arrangement of the receptacle for the file holder on a displaceably mounted carriage, adjustment of the file holder during the filing of the cutting tooth is possible in a simple manner.

### BRIEF DESCRIPTION OF THE DRAWINGS

The invention will now be described with reference to the drawings wherein:

FIG. 1 is a perspective view of an apparatus for filing a saw chain;

FIG. 2 is a plan view of the apparatus of FIG. 1;

FIG. 3 is a section view along the line in FIG. 2;

FIG. 4 is a plan view of the apparatus together with the saw chain and the guide of the apparatus placed on the saw chain;

FIG. 5 is a side view in the direction of the arrow V in FIG. 4;

FIG. 6 shows a side view in the direction of the arrow VI in FIG. 4; and,

FIGS. 7 to 9 are perspective illustrations of the guide in various positions of the carriage.

### DESCRIPTION OF THE PREFERRED EMBODIMENTS OF THE INVENTION

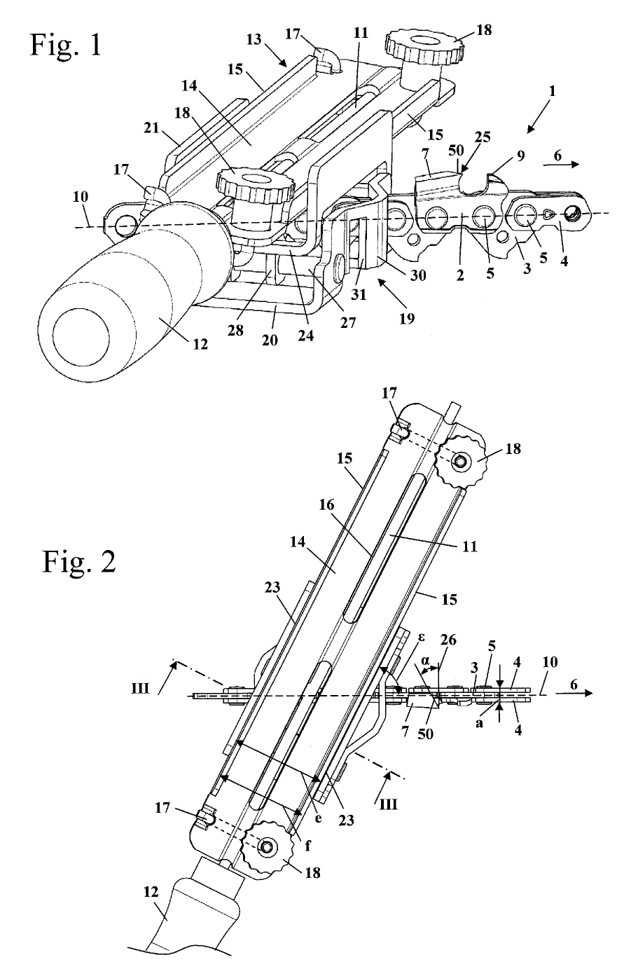

FIG. 1 shows a saw chain 1, which consists of central drive links 3 and lateral connecting links 4 which are connected together in an articulated manner via rivet pins 5. Some of the connecting links 4 are formed as cutting links 2, wherein the cutting links 2 alternately have a right-hand cutting tooth 7 and a left-hand cutting tooth 8 as seen in the running direction 6. Connecting links 4 are arranged in a leading and trailing manner between the cutting links 2. Provided in a manner leading each cutting tooth (7, 8) is a depth limiter 9, wherein the depth limiter 9 is integrally formed on the respective cutting link 2 in the exemplary embodiment. The right-hand cutting tooth 7 has a cutting edge 25 having a roof edge 50, and the left-hand cutting tooth 8 has, as shown in FIG. 4, a cutting edge 45 having a roof edge 51. The roof edge (50, 51) designates the upper, leading edge of the cutting tooth (7, 8) with this edge being located transversely to the longitudinal direction 10 of the saw chain 1.

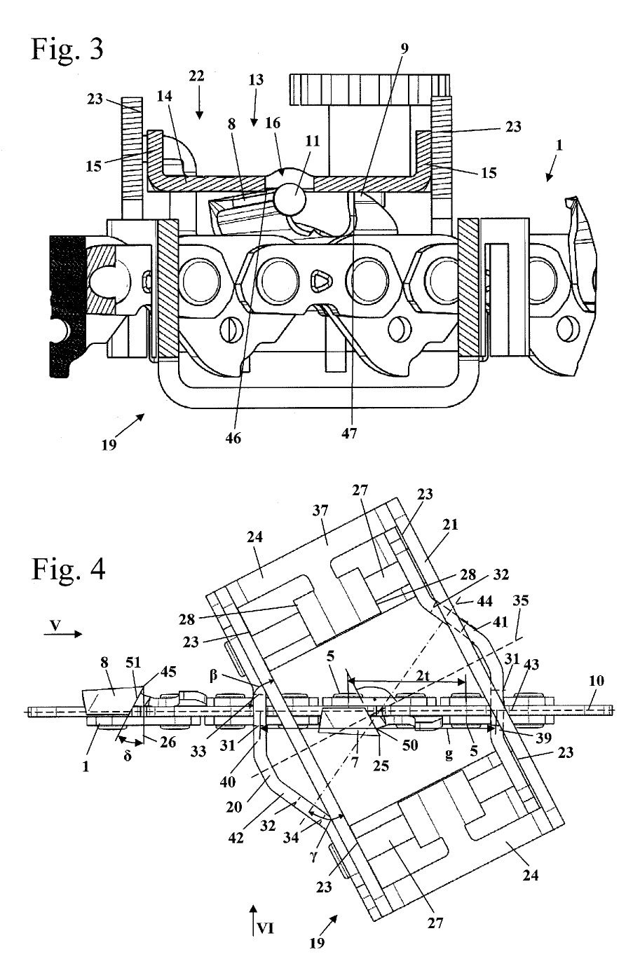

A guide 19 for a file holder 13 is placed on the saw chain 1. The file holder 13 has a base plate 14 along which parallel side walls 15 extend. Held on the base plate 14 is a file 11, which is aligned parallel to the side walls 15. The file 11 is firmly clamped to the file holder 13 via fixing clips 17 and fixing screws 18. The handle 12 of the file 11 projects outwardly away from the base plate 14, such that the file holder 13 having the file 11 can be guided by way of the handle 12. As FIGS. 2 and 3 show, the file 11 is arranged on the base plate 14 in a receptacle 16. The receptacle 16 is delimited by depressions in the base plate 14.

As FIG. 1 shows, the guide 19 has a seating or placement part 20, which is placed on the saw chain 1, and a carriage 21, which is mounted in a displaceable manner on the placement part 20. In order to mount the carriage 21 in a displaceable manner, the placement part 20 has two guide pins 27, which project through tongues 28 on the carriage 21 and thus guide the carriage 21 in the longitudinal direction of the guide pins 27. As FIG. 1 also shows, the placement part 20 has side walls 30 having cut-outs 31 for seating the placement part on the saw chain 1. The cut-outs 31 are explained in more detail hereinafter.

As FIG. 2 shows, the carriage 21 has two side guides 23, which extend parallel to and at a distance (e) from each other.

The distance (e) is approximately 100% to approximately 120% of the width (f) of the file holder 13. Advantageously, the file holder 13 is guided with little play between the side guides 23. As FIG. 2 shows, the side guides 23 extend at an angle (ε) to the longitudinal direction 10 of the saw chain 1. As a result, the file holder 13 is inclined with respect to the saw chain 1. FIG. 2 also shows the tooth angle (α), which the roof edge 50 of the cutting edge 25 of a right-hand cutting tooth 7 encloses with a perpendicular 26 to the longitudinal direction 10. FIG. 2 furthermore shows the width (a) of the saw chain 1 with the width (a) being measured in the region of connecting links 4 between the rivet pins 5. The side guide 23 extends parallel to the roof edge (50, 51) of the cutting edge (25, 45) of the cutting tooth (7, 8) to be filed.

FIG. 3 shows the arrangement of the file holder 13 on the guide 19. The file holder 13 is arranged in a receptacle 22 which is delimited by the side guides 23. In this case, the file holder 13 rests on the cutting tooth 8 to be filed at a first bearing point 46 and rests against the leading depth limiter 9 at a second bearing point 47. The file 11 is at a distance from the bottom 37, shown in FIG. 4, of the receptacle 22, such that the file holder 13 is guided exclusively on the cutting tooth 8, the depth limiter 9 and the side guides 23.

As FIG. 4 shows, the carriage 21 is mounted in a displaceable manner in a displacement direction 35 on the placement part 20. The displacement direction 35 is perpendicular to the cutting edge 25 of the right-hand cutting tooth 7 to be filed. The side guides 23 of the carriage 21 are connected together via two cross pieces 24, on which the tongues 28 are integrally formed. The guide pins 27 project through the tongues 28.

FIG. 4 shows the guide 19 in the position for filing a right-hand cutting tooth 7. In this position, the placement part 20 is placed by way of two first cut-outs 31 onto the saw chain 1. The center line 43 through the two first cut-outs 31 lies parallel to the longitudinal direction 10 of the saw chain 1 and coincides therewith in the plan view shown in FIG. 4. As FIG. 4 shows, the two cut-outs 31 are at a distance (g) from each other, this distance (g) corresponding to 4 times the pitch (t) of the saw chain 1. The pitch (t) is, in this case, half the distance of the center of one rivet pin 5 from the center of the next but one rivet pin 5. The distances between adjacent rivet pins 5 do not have to be the same in this case. The pitch (t) is the average distance between the rivet pins 5. In FIG. 4, twice the pitch 2t is shown. As FIG. 4 shows, the center line 43 encloses, with the side guide 23, an angle (β), which results in an angle of 90° with the tooth angle (α), shown in FIG. 2, of the right-hand cutting tooth 7. The two first cut-outs 31 are arranged in parallel wall sections (39, 40) of the placement part 20. The side walls 33 of the first cut-outs 31 extend parallel to the center line 43.

The placement part 20 has two further, second cut-outs 32, the center line 44 of which encloses an angle (γ) with the side guide 32. The angle (γ) results in an angle of 90° with a tooth angle (δ) of a left-hand cutting tooth 8. The tooth angle (δ) is measured between the roof edge 51 of the cutting edge 45 of the left-hand cutting tooth 8 and a perpendicular 26 to the longitudinal direction 10. The two second cut-outs 32 are arranged in parallel wall sections 41 and 42 of the placement part 20. The second cut-outs 32 have side walls 34 which extend parallel to the center line 44.

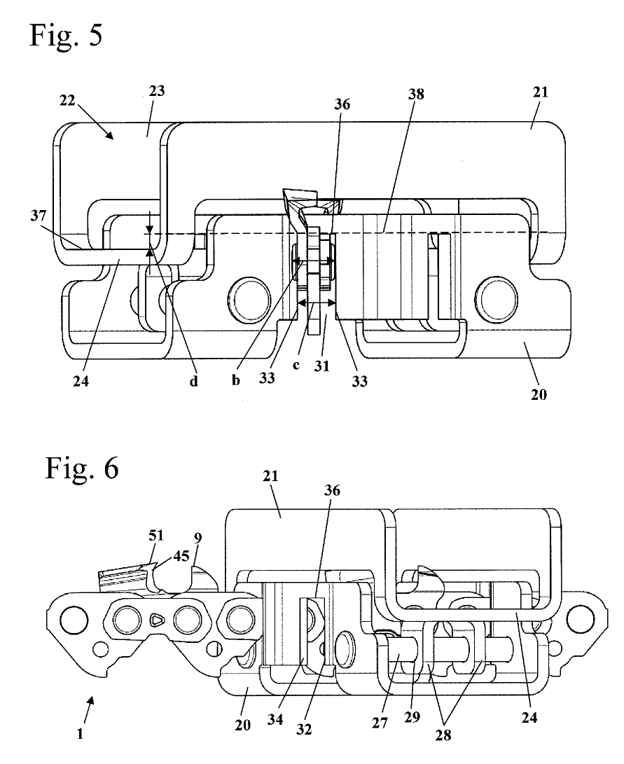

As FIG. 5 shows, the cut-out 31 has a width (c) which corresponds to the distance between the two side walls 33. The rivet pins 5 have a width (b) which is larger than the width (c) of the cut-out. As a result, the placement part 20 cannot be displaced beyond the rivet pins 5. The width (c) of the cut-out 31 is larger than the width (a) of the saw chain 1 between the rivet pins 5, such that the placement part 20 can be placed readily on the saw chain 1. The widths (a, b, c) are in this case measured perpendicularly to the longitudinal direction 10 of the saw chain 1.

The cut-out 31 has a top 36 which forms the upper edge of the cut-out 31 and rests on the saw chain 1. The tops 36 of the cut-outs 31 associated with one another lie, just like the tops 36 of the cut-outs 32, in an imaginary plane 38 which intersects the receptacle 22, that is, extends above the bottom 37 of the receptacle 22. The plane 38 does not lie below the receptacle 22 but rather projects through the receptacle 22. As a result, the saw chain 1 projects into the receptacle 22 from below. This ensures that the file 11 and the file holder 13 are guided only on the cutting tooth (7, 8) and the leading depth limiter 9 and not on the bottom 37 of the receptacle 22. In the exemplary embodiment, the bottom 37 is at a distance (d) from the plane 38, with this distance (d) being less than half the width (a) of the saw chain 1.

As FIG. 6 shows, the tongues 28 have openings 29, through which the guide pins 27 project. Because two tongues 28 are provided at each guide pin 27, tipping of the carriage 21 with respect to the placement part 20 is largely avoided, and good guidance is achieved.

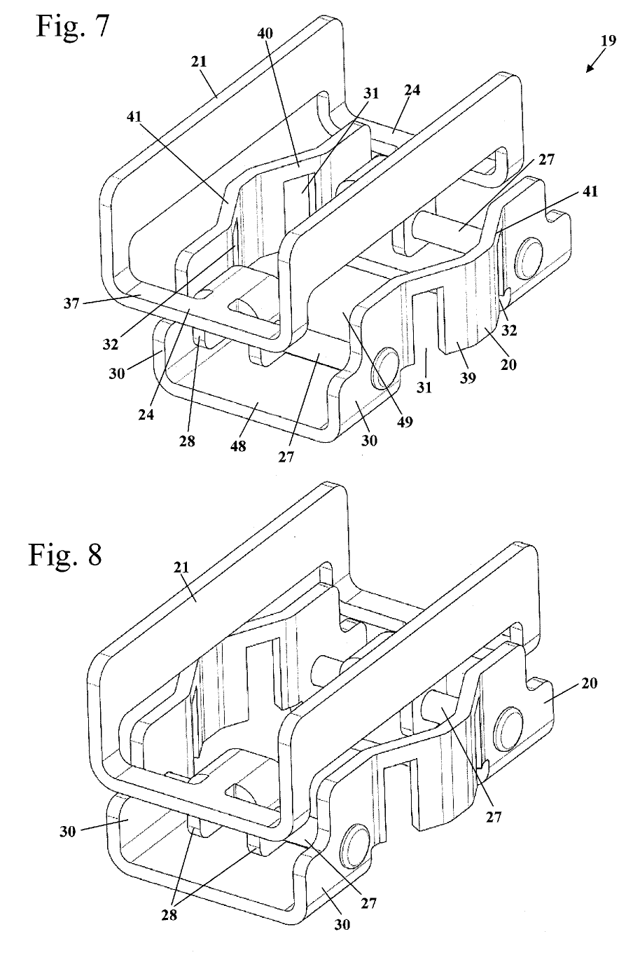

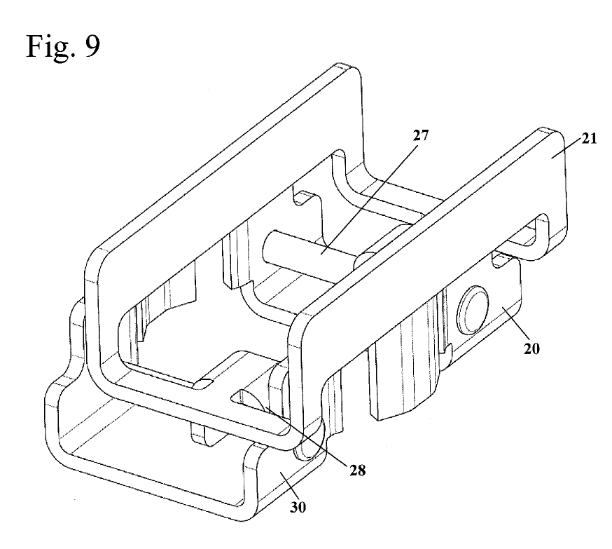

FIGS. 7 to 9 show the carriage 21 in various positions on the placement part 20. In the position shown in FIG. 7, one of the tongues 28 rests against the side wall 30 of the placement part 20. FIG. 8 shows the carriage 21 in a central position and FIG. 9 in a position in which the opposite tongue 28 rests against the opposite side wall 30.

FIGS. 7 to 9 show the general structure of the guide 19. The placement part 20 and the carriage 21 are each configured as bent sheet-metal parts which have previously been punched out. The placement part 20 has a bottom 48, which has an opening 49 in the region between the cut-outs 31 and 32, it being possible for the saw chain 1 to project into the interior of the guide 19 through the opening 49. The bottom 37 of the receptacle 22 is formed only by the two cross pieces 24. The cross pieces 24 are arranged next to the end sides of the guide 19. The side walls 30 of the placement part 20 project into the region between the cross pieces 24. In the region of the cut-outs 31 and 32, the side walls 30 of the placement part 20 are curved outward and thus form the parallel wall sections 39, 40, 41 and 42.

The receptacle 22 for the file holder 13 comprises also the space which is required for holding the files 11. The bottom 37 of the receptacle 22 does not absolutely have to be configured in a planar manner. In the case of a bottom 37 which is not configured in a planar manner, the receptacle 22 is defined by the region that projects farthest into the placement part 20.

It is understood that the foregoing description is that of the preferred embodiments of the invention and that various changes and modifications may be made thereto without departing from the spirit and scope of the invention as defined in the appended claims.

What is claimed is:

1. An apparatus for filing a saw chain defining a longitudinal direction, the saw chain having a plurality of cutting teeth and a plurality of depth limiters associated with and disposed ahead of corresponding ones of said cutting teeth viewed running in said longitudinal direction of the saw chain, the apparatus comprising:
a file;
a file holder for holding said file;
a guide configured for said file holder;
said guide having a placement part configured to be placed on said saw chain;
said guide including a carriage configured as a receptacle for said file holder;
said carriage being mounted on said placement part so as to be displaceable in a displacement direction transverse to said longitudinal direction of said saw chain;
said file holder being guided on said carriage at an angle (ε) to said longitudinal direction of said saw chain; and,
said file holder being configured to be supported on the one of said cutting teeth of said saw chain which is to be filed and on the depth limiter corresponding to said one cutting tooth which is to be filed.

2. The apparatus of claim 1, wherein:
said cutting teeth each have a top edge defining a cutting edge; and,
said displacement direction is perpendicular to said top edge of the cutting tooth to be filed when said guide is mounted on said saw chain.

3. The apparatus of claim 1, wherein:
said carriage has two side guides; and,
said file holder is guided between said two side guides of said carriage.

4. The apparatus of claim 3, wherein:
said side guides run parallel to each other and define a distance (e) between each other;
said file holder having a width (f); and,
said distance (e) is approximately 100% to approximately 120% of said width (f).

5. The apparatus of claim 3, wherein:
said placement part has at least two cut-outs which are associated with each other and with which said placement part is configured to be seated on said saw chain; and,
said cut-outs defining a center line which together with said side guides of said carriage enclose an angle (β, γ) which together with a tooth angle (α, δ) of the saw chain results in an angle of 90°.

6. The apparatus of claim 5 further comprising:
said placement part having at least two mutually parallel wall sections; and,
said cut-outs associated with each other being arranged in corresponding ones of said parallel wall sections.

7. The apparatus of claim 5, wherein:
said saw chain has a pitch (t);
said two cut-outs, which are associated with each other, define a distance (g) between each other; and,
said distance is approximately four times said pitch (t).

8. The apparatus of claim 3, wherein a first portion of said cutting teeth are left cutting teeth and a second portion of said cutting teeth are right cutting teeth;
said guide has two first cut-outs which are associated with each other and with which said placement part is configured to be seated on said saw chain;
said first cut-outs defining a first center line which together with said side guides of said carriage enclose an angle (β) which together with a tooth angle (α) of one of said right cutting teeth results in an angle of 90°; and,
said guide has two second cut-outs that define a second center line which together with said side guides of said carriage encloses an angle (γ) which together with a tooth angle (δ) of one of said left cutting teeth results in an angle of 90°.

9. The apparatus of claim 5, wherein:
said saw chain has a plurality of connecting links each having two rivet pins with each of said rivet pins having a width (b);
said saw chain has a width (a) between said rivet pins; and,
said cut-outs have a width (c) which is greater than said width (a) of said saw chain between said rivet pins and is less than said width (b) of said rivet pins.

10. The apparatus of claim 5, wherein said cut-outs have roofs which all lie in a plane which projects through said receptacle for said file holder.

11. The apparatus of claim 3 further comprising:
at least one cross-member which connects said side guides of said carrier to each other and has at least one tongue configured to displaceably mount said carriage on said placement part; and,
said receptacle having a base defined by said cross-member.

12. A guide for a file holder having a file for filing a saw chain, the guide comprising:
a placement part configured to be seated on the saw chain;
a carriage mounted on said placement part in such a manner so as to be displaceable in a displacement direction;
said carriage having two parallel side guides;
said side guides being arranged at a distance to each other and perpendicular to said displacement direction; and,
said side guides delimiting a receptacle for said file holder.

13. The guide of claim 12, wherein:
said placement part has at least two cut-outs configured for seating on the saw chain; and,
said cut-outs each having respective roofs lying in a plane which projects through said receptacle for said file holder.
